(19) United States
(12) Patent Application Publication
(10) Pub. No.: US 2006/0277428 A1
(43) Pub. Date: Dec. 7, 2006

(54) A system and method for simulation of electronic circuits generating clocks and delaying the execution of instructions in a plurality of processors

(75) Inventors: SUBBU GANESAN, SARATOGA, CA (US); LEONID ALEXANDER BROUKHIS, FREMONT, CA (US); RAMESH NARAYANASWAMY, PALO ALTO, CA (US); IAN MICHAEL NIXON, SUNNYVALE, CA (US); THOMAS HANNI SPENCER, SUNNYVALE, CA (US)

Correspondence Address: PATENTRY, P.O. BOX 151616, SAN RAFAEL, CA, 94915-1616, US

(73) Assignee: Tharas Systems Inc., Santa Clara, CA (US)

(21) Appl. No.: 11/379,046

(22) Filed: Apr. 17, 2006

Related U.S. Application Data
(63) Continuation-in-part of application No. 11/307,198, filed on Jan. 26, 2006.
(60) Provisional application No. 60/595,057, filed on Jun. 2, 2005.

(51) Int. Cl. G06F 1/00

(52) U.S. Cl. 713/500

(57) ABSTRACT

A method for generating clocks and delaying execution of an instruction within a hardware accelerator.

### CROSS-REFERENCE TO RELATED APPLICATIONS

The present application claims the benefit of priority under 35 USC .sctn. 119(e) from U.S. provisional patent application 60/595,057 filing date Jun. 02, 2005 first named inventor Ganesan, titled: “Massively parallel platform for accelerated verification of hardware and software.” The present application is a continuation in part of U.S. patent application Ser. No. 11/307198 filing date Jan. 26, 2006 first named inventor Ganesan, titled: “A scalable system for simulation and emulation of electronic circuits using asymmetrical evaluation and canvassing instruction processors”.

### BACKGROUND OF THE INVENTION

### FIELD OF THE INVENTION

The present invention relates to the electronic design of integrated circuits. Functional verification is one of the steps in the design of integrated circuits. Functional verification generally refers to determining whether a design representing an integrated circuit performs a function it is designed for. In conventional hardware accelerated simulators, master clocks and asynchronous events are managed in the attached host computer running a software program. When circuit under verification is desired to be clocked or receive a stimulus, the host control interface between the host computer and the hardware accelerator must be activated and process an interrupt creating a bottleneck in the process.

Thus it can be appreciated that what is needed is a method of operating a scalable architecture for a plurality of processors with clocks generated within the processors.

### SUMMARY OF THE INVENTION

The present invention enables the execution of an instruction with a specified delay. The instruction is executed when its Time_To_Go register is determined to have a zero value. Every delay register is decremented an amount corresponding to the smallest delay found among all of the Time_To_Go registers.

The invention further comprises a compiler which converts a hardware description language notation to a plurality of delay values and instructions executable with the evaluation processors to model clocks and arbitrarily delayed signals.

### DESCRIPTION OF DRAWINGS

FIG. 1 is a flow chart of a method to delay execution of an instruction.

FIG. 2 is a block diagram of data flow among storage devices.

### DETAILED DESCRIPTION

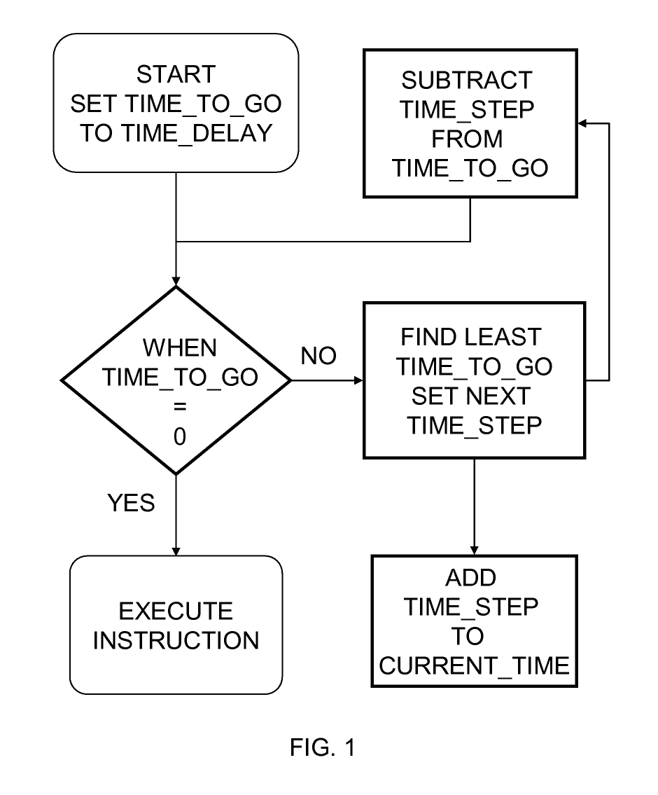

Referring to FIG. 1, a process is disclosed comprising the steps of setting a time_to_go equal to the value of a certain time-delay, setting a time_step equal to the least non-zero time_to_go, subtracting the time_step from time_to_go, and executing an instruction when time_to_go first equals zero.

The process further comprises accumulating the time_steps from the start to compute the current_time which may be recorded with the instructions in a log.

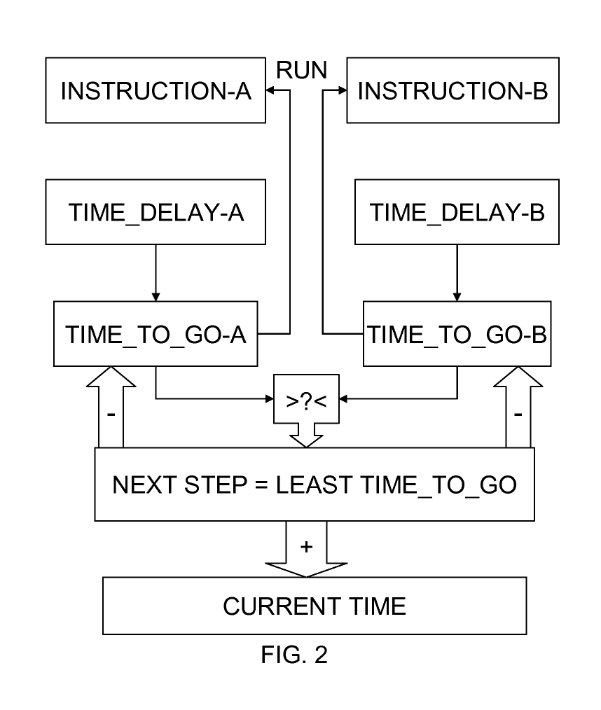

Referring to FIG. 2, a data flow and control block diagram is disclosed comprising a plurality of instruction registers containing instruction which are executed when the contents of the time_to_go registers first become zero, a plurality of time_to_go registers which are set equal to the contents of time_delay registers when their respective process starts, a time_step register labeled “next step=least time_to_go” which is set to equal the minimum non-zero value of at least one time_to_go register. Every time_step is subtracted from each non-zero time_to_go register and added to the current_time register.

The present invention is a system comprising a plurality of processors, a plurality of storage devices, interconnecting circuitry and a process for delaying the execution of at least one instruction,

the processors comprising
a time_step processor,
at least one instruction processor, and
at least one trigger processor;

the storage devices comprising
a time_step register,
at least one instruction register,
at least one time_delay register, and
at least one time_to_go register,

the interconnect circuitry comprising
at least one circuit for transferring each time_step from the time_step processor to at least one trigger processor, and
at least one circuit for transferring the time_delay to the trigger processor;

the process for delaying the execution of at least one instruction comprising the following steps:
executing at least one instruction when a time_to_go register first equals zero,
subtracting a time_step from at least one time_to_go register,
setting a time_step equal to the minimum value of time_to_go of at least one time_to_go register, and
setting time_to_go equal to time_delay at the start of the process.

The present invention further comprises a current_time processor, a current_time register, a circuit for transferring each time_step from the time_step processor to the current time processor, and the process of accumulating time_steps from the start of the process to compute the current_time.

The present invention may be tangibly embodied in a computer-readable medium adapted to control the operation of at least one processor to perform the following process:
setting at least one time_to_go register to a certain non-zero time_delay value to start the process,
setting a time_step register to a time_step equal to the minimum non-zero value of time_to_go,
subtracting the time_step from at least one time_to_go register, and
executing at least one instruction when time_to_go first becomes zero.

It can be appreciated that there is an advantage to the subsequent process of adding each time_step from the start of the process to determine the current_time.

A illustrative but simple example of the present invention is a two state system for delaying the start of a square wave clock signal composed of an equal amount of time at value-A and at its inverse value-B comprising

two instruction registers, two time_delay registers, two time_to_go registers, and a time step register, and a method comprising the steps following:
delaying the start of clock by loading a first time_to_go-A register from its time_delay-A register with the amount of time to delay starting the clock,
setting the time_step to the minimum non-zero time_to_go,
subtracting the time_step from the time_to_go-A, and
executing instruction-A to set the value of the clock to value-A and start the clock state,
setting the time_to_go-B register from its time_delay-B register with one-half of a clock period,
setting the time_step to the minimum non-zero time_to_go,
subtracting the time_step from the time_to_go-B, and
executing instruction-B to invert the value of the clock and restart the clock state.

A more generally useful embodiment of the present invention is a three state system for delaying the start of a clock signal composed of an certain amount of time at value-B and a certain amount of time at value-C comprising three instruction registers, three time_delay registers, three time_to_go registers, and a time step register, and a method comprising the steps following:
delaying the start of clock by loading a first time_to_go-A register from its time_delay-A register with the amount of time to delay starting the clock,
setting the time_step to the minimum non-zero time_to_go,
subtracting the time_step from the time_to_go-A, and
executing instruction-A to set the value of the clock to value-B, and start the phase one clock state;
setting the time_to_go-B register from its time_delay-B register with the amount of time the clock is defined to be at value-B,
setting the time_step to the minimum non-zero time_to_go,
subtracting the time_step from the time_to_go-B, and
executing instruction-B to set the value of the clock to value C and start the phase two clock state;
setting the time_to_go-C register from its time_delay-C register with the amount of time the clock is defined to be at value-C,
setting the time_step to the minimum non-zero time_to_go,
subtracting the time_step from the time_to_go-C, and
executing instruction-C to set the value of the clock to value B and start the phase one clock state.

In short the invention is a method for advancing time comprising the steps of finding a minimum value of time_to_go and subtracting the minimum value from all time_to_go registers. The invention may be tangibly embodied by a program product which compiles a Verilog delay instruction into a time_delay, a time_step instruction and trigger instruction.

The present invention is a system for verifying electronic circuit designs in anticipation of fabrication by simulation and emulation. The system uses
a plurality of evaluation processors, and
a software product compiler, tangibly encoded on a computer readable storage device as instructions controlling a computer system to perform the following method: analyzing a circuit description for inherent circuit value data transfer activity among its elements, translating the circuit description to evaluation processor instructions, assigning the evaluation processor instructions to certain storage devices associated with certain evaluation processors to optimize circuit value data transfer, generating canvassing processor instructions to ensure that results from certain evaluation processors are transferred to certain other evaluation processors according to the circuit description, scheduling the execution of evaluation processor instructions and canvassing processor instructions to avoid deadlock, and transferring certain evaluation results to the host computer interface.

Certain of the evaluation instructions comprise the following steps:
loading a time_step register with a value,
subtracting the value of the time_step register from the value in the time_to_go register,
launching an instruction when the value in the time_to_go register becomes zero.

In one simple embodiment the method generates an inverting clock comprising the step of loading the instruction register with an instruction to invert the value of the signal named Clock_A and initializing the time_to_go register with a value equal to half the period of the clock. A clock is defined as a signal that repeatedly alternates between two values with a fixed duration at one value and the same or a different fixed duration at the other value.

More generally the invention is a method for generating at least one general purpose parameterized clock further comprising the steps of:
reading one or more of the following: a begin_state_value, a begin_duration, a first_state_value, a first_state_duration, a second_state_value, a second_state_duration, and an optional clock_activity_duration.
initializing a begin time process by loading the time_delay with the begin_duration, and the instruction with setting the clock to the first_state_value and disabling the begin time process,
initializing a first time process by loading the time_delay with the first_state_duration, and the instruction with setting the clock to the second_state_value,
initializing a second time process by loading the time_delay with the second_state_duration, and the instruction with setting the clock to the first_state_value,
setting the clock to the begin_state_value, and
loading the time_to_go with the begin_duration.

The method is made more useful by further comprising at least one of the following: a global instruction disable and an individual clock disable by maintaining a do_trigger register initialized with “true”, performing clock inversion conditioned on the value of the do_trigger register, maintaining a time_to_disable register initialized with the activity duration of the clock the same way as the time_to_go registers while do_trigger is “true”, and assigning “false” to do_trigger when time_to_disable reaches 0. Another use would be to provide instruction offset delays so that some time after instruction A is executed, an instruction B is executed.

The present invention is a method of advancing time comprising the steps of finding a minimum value of time_to_go and subtracting the minimum value from all time_to_go registers. Let's say the minimum value is always 5. In that case current_time skips forward as 5, 10, 15, 20 . . . .

The method further comprises delaying the execution of an instruction by executing an instruction when a time_to_go register first becomes zero.

The compiler further embodies a method for modeling a clock in the user's design that can be compiled to hardware accelerator machine instructions wherein the hardware accelerator may self clock and not be slaved to a clock signal generated from a host resident software simulator, the method consisting of the following steps:
maintaining the current time T in ticks as a register vector, initialized to 0, maintaining a set of time variables R—one per clock—holding the time remaining until the next event,
computing the minimum (M) of the values of these variables and in an embodiment using a balanced tree of less-than comparators for efficiency,
incrementing T by M,
decrementing R variables by M,
executing for those clocks corresponding to R variables that are equal to 0,
at least one of the following instructions: updating the value of the clock signal either to the inverse of the current value, or
to the first phase value if the current value is X AND assigning the phase duration corresponding to the new value of the clocks (pos or neg) to the corresponding R variables,
maintaining an oscillating clock C where the oscillation is triggered by E (assign C=C ˆ E), thereby allowing the user code to stop the simulation by assigning 0 to E, and instructing the compiler and the sequence processor to treat C as a special clock to signify that the oscillation of that clock is expected while still allowing to detect possible oscillations of the derived clocks in the design under test, and finally,
sending the updated value of current time T to the host simulator: for such uses as $display, $time, . . . calls and
injecting a time advance mark (timestep value or the current time T) to the signal trace stream.

In an embodiment of the present invention, a list of clock waveform descriptions in the form (initial value (may be X), initial duration, first phase value, pos phase duration, neg phase duration) are mapped from a Verilog, C, or VHDL compatible syntax to hardware instruction code that maintains the notion of current time and manipulates the clock signals according to the descriptions.

Although particular embodiments of the present invention have been shown and described, it will be obvious to those skilled in the art that changes and modifications may be made without departing from the present invention in its broader aspects, and therefore, the appended claims are to encompass within their scope all such changes and modifications that fall within the true scope of the present invention.

Conclusion

The present invention addresses the issue of handling clocks and more generally delayed execution of instructions by managing time within a hardware simulation accelerator without recourse to host computer resources and attendant overhead. The present invention provides means for electronics design engineers to efficiently execute instructions compiled from a hardware description language functional model of a hypothetical system prior to fabrication on a plurality of processors including instruction such as wait 1 2 ticks without interrupting the hardware for a host control interrupt.

What is claimed is:

1. A system comprising a plurality of processors, a plurality of storage devices, interconnecting circuitry and a process for delaying the execution of at least one instruction,
the processors comprising
a time_step processor,
at least one instruction processor, and
at least one trigger processor;
the storage devices comprising
a time_step register,
at least one instruction register,
at least one time_delay register, and
at least one time_to_go register,
the interconnect circuitry comprising
at least one circuit for transferring each time_step from the time_step processor to at least one trigger processor, and
at least one circuit for transferring the time_delay to the trigger processor;
the process for delaying the execution of at least one instruction comprising the following steps:
executing at least one instruction when a time_to_go register first equals zero,
subtracting a time_step from at least one time_to_go register,
setting a time_step equal to the minimum value of time_to_go of at least one time_to_go register, and
setting time_to_go equal to time_delay at the start of the process.

2. The system of claim 1 further comprising a current_time processor, a current_time register, a circuit for transferring each time_step from the time_step processor to the current time processor, and the process of accumulating time_steps from the start of the process to compute the current_time.

3. A program product tangibly embodied in a computer-readable medium adapted to control the operation of at least one processor to perform the following process:
setting at least one time_to_go register to a certain non-zero time_delay value to start the process,
setting a time_step register to a time_step equal to the minimum non-zero value of time_to_go,
subtracting the time_step from at least one time_to_go register, and
executing at least one instruction when time_to_go first becomes zero.

4. The program product of claim 3 further comprising the step of adding each time_step from the start of the process to determine the current_time.

5. A method for generating at least one general purpose parameterized clock comprising the steps of:
reading one or more of the following: a begin_state_value, a begin_duration, a first_state_value, a first_state_duration, a second_state_value, a second_state_duration, and an optional clock_activity_duration,
initializing a begin time process by loading the time_delay with the begin_duration, and the instruction with setting the clock to the first_state_value and disabling the begin time process,
initializing a first time process by loading the time_delay with the first_state_duration, and
the instruction with setting the clock to the second_state_value,
initializing a second time process by loading the time_delay with the second_state_duration, and the instruction with setting the clock to the first_state_value,
setting the clock to the begin_state_value, and
loading the time_to_go with the begin_duration.

6. The method of claim 5 further comprising at least one of the following: a global instruction disable method and an individual clock disable method wherein an individual clock disable method comprises:
maintaining a do_trigger register initialized with “true”,
performing clock inversion conditioned on the value of the do_trigger register,
maintaining a time_to_disable register initialized with the activity duration of the clock the same way as the time_to_go registers while do-trigger is “true”, and
assigning “false” to do_trigger when time_to_disable reaches 0.

7. A system for delaying the start of a square wave clock signal composed of an equal amount of time at value-A and at its inverse comprising two instruction registers, two time_delay registers, two time_to_go registers, and a time step register, and a method comprising the steps following:
delaying the start of clock by loading a first time_to_go-A register from its time_delay-A register with the amount of time to delay starting the clock,
setting the time_step to the minimum non-zero time_to_go,
subtracting the time_step from the time_to_go-A, and
executing instruction-A to set the value of the clock to value-A and start the clock state,
setting the time_to_go-B register from its time_delay-B register with one-half of a clock period,
setting the time_step to the minimum non-zero time_to_go,
subtracting the time_step from the time_to_go-B, and
executing instruction-B to invert the value of the clock and restart the clock state whereby two states are modeled.

8. The system of claim 7 for delaying the start of a clock signal composed of an certain amount of time at value-B and a certain amount of time at value-C further comprising
three instruction registers, three time_delay registers, three time_to_go registers, and a time step register, and a method comprising the steps following:
delaying the start of clock by loading a first time_to_go-A register from its time_delay-A register with the amount of time to delay starting the clock, setting the time_step to the minimum non-zero time_to_go, subtracting the time_step from the time_to_go-A, and
executing instruction-A to set the value of the clock to value-B, and start the phase one clock state,
setting the time_to_go-B register from its time_delay-B register with the amount of time the clock is defined to be at value-B, setting the time_step to the minimum non-zero time_to_go, subtracting the time_step from the time_to_go-B, and executing instruction-B to set the value of the clock to value C and start the phase two clock state,
setting the time_to_go-C register from its time_delay-C register with the amount of time the clock is defined to be at value-C, setting the time_step to the minimum non-zero time_to_go, subtracting the time_step from the time_to_go-C, and executing instruction-C to set the value of the clock to value B and start the phase one clock state whereby three states are modeled.

9. A method for advancing time comprising the steps of finding a minimum value of time_to_go and subtracting the minimum value from all time_to_go registers.

10. The method of claim 9 further comprising compiling a Verilog delay instruction into a time_delay, a time_step instruction and trigger instruction.

11. The method of claim 9 for executing a plurality of evaluation instructions to generate a periodic clock signal within the array of processors whereby the host control interface is not interrupted to insert clock signals, the method further comprising the steps following: maintaining the
current time T in ticks as a register vector, initialized to 0,
maintaining a set of time variables R
initializing the variables R to the initial duration of the corresponding clock,
computing the minimum (M) of the values of these variables
incrementing T by M,
decrementing R variables by M, wherein for those clocks corresponding to R variables that are equal to 0,
executing at least one of the following instructions:
updating the value of the clock signal either to the inverse of the current value, or to the first phase value if the current value is X AND assigning the phase duration corresponding to the new value of the clocks (pos or neg) to the corresponding R variables,
sending the updated value of T to the host simulator: for the $display($time, . . . ) calls and $dumpvars to work correctly, and
injecting a time advance mark to the signal trace stream.
